(19) United States
(12) Patent Application Publication
(10) Pub. No.: US 2006/0042858 A1
(43) Pub. Date: Mar. 2, 2006

(54) Steer-by-wire steering apparatus with redundant electric motor drive systems

(75) Inventors: Kevin E. Boyle, Lebanon, IN (US); William A. Szabela, Brookston, IN (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive U.S. LLC

(21) Appl. No.: 10/924,609

(22) Filed: Aug. 24, 2004

(51) Int. Cl. B62D 5/00

(52) U.S. Cl. 180/402

(57) ABSTRACT

A steering apparatus (10) includes first and second assemblies (16 and 26). The second assembly (26) includes a steering gear (28) and first and second drive units (30 and 32), each for actuating the steering gear (28). The second assembly (26) has first and second modes of operation. The first and second drive units (30 and 32) operate simultaneously for actuating the steering gear (28) when the second assembly (26) is operating in the first mode of operation. Only one of the first and second drive units (30 and 32) is operated when the second assembly (26) is operating in the second mode of operation.

### TECHNICAL FIELD

The present invention relates to a steering apparatus for turning the steerable wheels of a vehicle in response to rotation of a vehicle steering wheel. More particularly, the present invention relates to a steer-by-wire steering apparatus for turning the steerable wheels of a vehicle.

### BACKGROUND OF THE INVENTION

Power steering gears are common in modern vehicles. Typically, one or more rigid shafts connect a vehicle steering wheel to an input shaft of the power steering gear. The rigid shafts must be routed from the vehicle steering wheel to the input shaft of the power steering gear. Routing the rigid shafts between the steering wheel and the steering gear is often difficult, as other vehicle components must not interfere with the shafts.

Some known vehicle steering systems have eliminated the rigid shafts. Such systems are commonly referred to as “steer-by-wire” systems. In steer-by-wire systems, there is no mechanical connection between the steering wheel and the steering gear. Instead, a first assembly is associated with the steering wheel. The first assembly sends electronic signals to a second assembly that includes the power steering gear. The second assembly also includes a drive unit that is responsive to the electronic signals for actuating the power steering gear to turn the steerable wheels of the vehicle.

In a steer-by-wire system, a malfunction or failure of a portion of the second assembly may result in an inability to steer the vehicle. As a result, it is desirable to provide the second assembly with structure for providing at least temporary fail-safe operation.

### SUMMARY OF THE INVENTION

The present invention relates to a steering apparatus for turning steerable wheels of a vehicle in response to rotation of a steering wheel. The steering apparatus comprises a first assembly that is operatively coupled to the steering wheel and that includes components for sensing conditions of the steering wheel and for providing a control signal indicative of the sensed conditions. The steering apparatus also comprises a second assembly that includes a steering gear for, when actuated, turning the steerable wheels of the vehicle. The second assembly also includes first and second drive units. Each of the first and second drive units is operatively connected to an input shaft of the steering gear and is responsive to the control signal for actuating the steering gear. The second assembly has first and second modes of operation. The first and second drive units operate simultaneously in response to the control signal for actuating the steering gear when the second assembly is operating in the first mode of operation. Only one of the first and second drive units is operated in response to the control signal for actuating the steering gear when the second assembly is operating in the second mode of operation.

According to another aspect, the present invention relates to a steering apparatus for turning steerable wheels of a vehicle in response to rotation of a steering wheel. The steering apparatus comprises a first assembly that is operatively coupled to the steering wheel and that includes components for sensing conditions of the steering wheel and for providing a control signal indicative of the sensed conditions of the steering wheel. The steering apparatus also comprises a second assembly that includes a steering gear for, when actuated, turning the steerable wheels of the vehicle. The second assembly also includes first and second drive units. Each of the first and second drive units is operatively connected to an input shaft of the steering gear and is responsive to the control signal for actuating the steering gear. The second assembly includes a gear assembly for operatively connecting the first and second drive units to the steering gear. The gear assembly includes a worm wheel that is fixed to the input shaft of the steering gear. A first worm gear is associated with the first drive unit and is in meshing engagement with the worm wheel for driving the worm wheel. A second worm gear is associated with the second drive unit and is in meshing engagement with the worm wheel for driving the worm wheel.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of a steering apparatus constructed in accordance with the present invention;

FIG. 2 illustrates a first portion of the steering apparatus of FIG. 1;

FIG. 3 illustrates a second portion of the steering apparatus of FIG. 1;

FIG. 4 is a schematic elevation view, partially in section, of a steering gear of the steering apparatus of FIG. 1; and

FIG. 5 is a flow diagram illustrating an exemplary process performed by an electronic control unit of a drive unit of a steering apparatus constructed in accordance with the present invention.

### DETAILED DESCRIPTION OF THE INVENTION

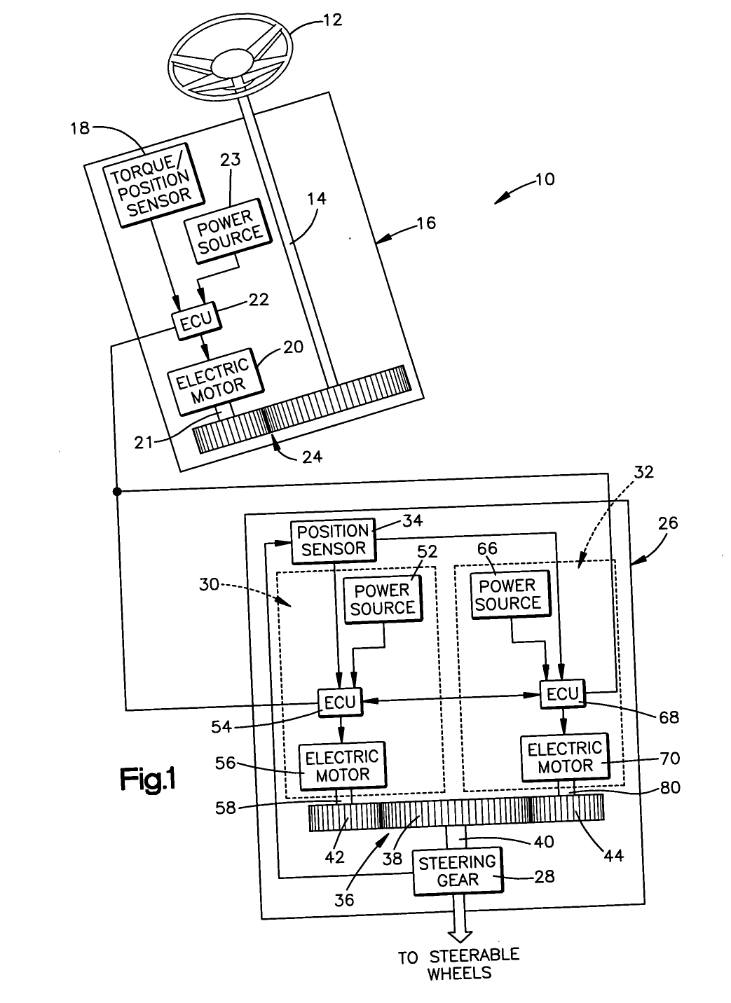

FIG. 1 schematically illustrates a vehicle steering apparatus 10 constructed in accordance with the present invention. The steering apparatus 10 includes a steering wheel 12. The steering wheel 12 is of known construction and is manually rotatable by a vehicle operator (not shown).

A shaft 14 is fixed to the center or hub of the steering wheel 12. Angular rotation of the steering wheel 12 results in an equivalent angular rotation of the shaft 14. The shaft 14 extends from the steering wheel 12 and into a first assembly 16.

The first assembly 16 is operatively coupled to the steering wheel 12 via the shaft 14. The first assembly 16 includes a torque/position sensor 18, a first electric motor 20, a first electronic control unit 22, and a first power source 23. The first assembly 16 is integrated into a single unit into which the shaft 14 extends.

The torque/position sensor 18 of the first assembly 16, shown schematically in FIG. 1, is operable to sense operator applied torque and the angular position of the steering wheel 12. The torque/position sensor 18 outputs signals indicative of the sensed applied torque and angular position of the steering wheel 12. The torque/position sensor 18 may be any known sensor or group of sensors for sensing the applied torque and angular position of the steering wheel 12 and for outputting signals indicative of the sensed conditions. In one embodiment, the torque/position sensor 18 is an optical sensor.

The first electric motor 20 is connected to the shaft 14. Preferably, a first gear assembly 24 connects an output shaft 21 of the first electric motor 20 to the shaft 14. The first electric motor 20 is actuatable to provide resistance to rotation of the steering wheel 12 and thus, is commonly referred to as a “steering feel motor.”

The first electronic control unit 22 is operatively coupled to the torque/position sensor 18 and to the first electric motor 20. The first electronic control unit 22 receives the signals indicative of the applied torque and angular position of the steering wheel 12 from the torque/position sensor 18. In response to the signals from the torque/position sensor 18, the first electronic control unit 22 outputs a control signal corresponding to the sensed torque and angular position of the steering wheel 12. The first electronic control unit 22 is also responsive to the sensed torque and angular position of the steering wheel for controlling the first electric motor 20 to provide resistance to rotation of the steering wheel 12.

The first power source 23 preferably is a battery of the vehicle. In a vehicle that includes more than one battery, the first power source 23 may be a single battery or a combination of multiple batteries.

The second assembly 26 includes a power steering gear 28, first and second drive units 30 and 32, respectively, and a position sensor 34 for sensing a position of the power steering gear. A second gear assembly 36 operatively connects the first and second drive units 30 and 32 to the power steering gear 28. The second gear assembly 36 includes a first gear 38 that is fixed for rotation on an input shaft 40 of the power steering gear 28, a second gear 42 that is associated with the first drive unit 30 and that is in meshing engagement with the first gear 38, and a third gear 44 that is associated with the second drive unit 32 and also that is in meshing engagement with the first gear 38.

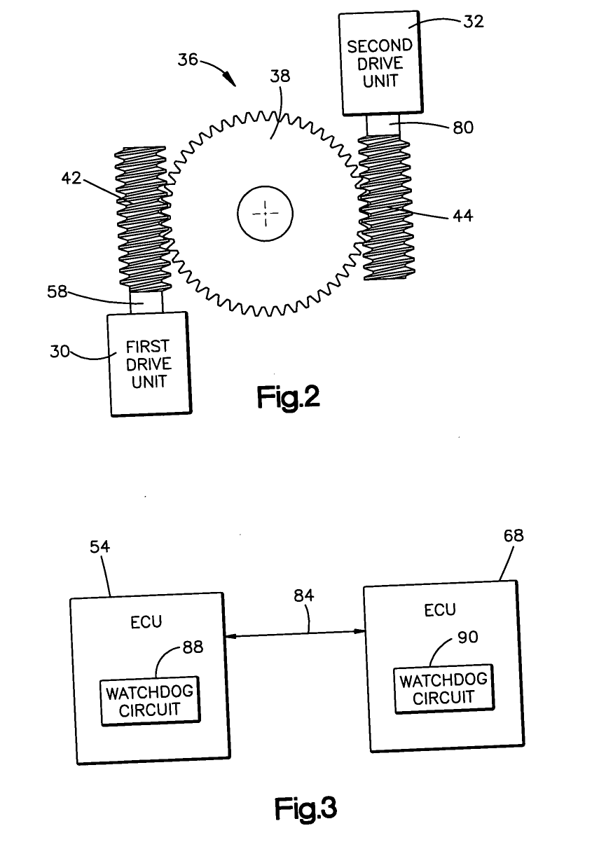

FIG. 2 illustrates a preferred embodiment of the second gear assembly 36 for operatively connecting the first and second drive units 30 and 32 to the input shaft 40 of the power steering gear 28. As illustrated in FIG. 2, the first gear 38 of the second gear assembly 36 is a worm wheel and the second and third gears 42 and 44 are worm gears. The gear teeth of the worm gears 42 and 44 are configured so that for each rotation of the worm gears the worm wheel is rotated by a small angle, such as two degrees. Thus, the second gear assembly 36 is a reduction gear assembly.

The first drive unit 30 of the second assembly 26 includes a second power source 52, a second electronic control unit 54, and a second electric motor 56. The second power source 52 is preferably a battery of the vehicle. The first and second power sources 23 and 52 may share a common battery.

The second electronic control unit 54 is preferably a microcomputer. Alternatively, the second electronic control unit 54 may be formed from discrete circuitry, an application-specific-integrated-circuit (“ASIC”), or any other type of control circuitry. The second electronic control unit 54 is operatively connected to the first electronic control unit 22 of the first assembly 16 and receives the control signals, which corresponds to the sensed torques and angular positions of the steering wheel 12, from the first electronic control unit. The second electronic control unit 54 is responsive to the control signals from the first electronic control unit 22 for controlling actuation of the second electric motor 56.

The second electric motor 56 is operatively connected to the power steering gear 28. The second gear 42 of the second gear assembly 36 is fixed for rotation on an output shaft 58 of the second electric motor 56. The second electric motor 56 is a reversible motor. The second electronic control unit 54 is responsive to the control signals for controlling the direction of rotation of the output shaft 58 of the second electric motor 56. The second electronic control unit 54 also controls the speed and applied torque of the second electric motor 56.

When the second electric motor 56 is operated, the output shaft 58 of the second electric motor 56 rotates the second gear 42. Rotation of the second gear 42 causes the first gear 38 of the second gear assembly 36 to rotate, which in turn, causes rotation of the input shaft 40 of the power steering gear 28. As is described in detail below, rotation of the input shaft 40 of the power steering gear 28 results in movement of the steerable wheels of the vehicle.

The second drive unit 32 includes a third power source 66, a third electronic control unit 68, and a third electric motor 56. The third power source 66 is preferably a battery of the vehicle and is different from the second power source 52. The first and third power sources 23 and 66 may share a common battery.

The third electronic control unit 68 is preferably a microcomputer. Alternatively, the third electronic control unit 68 may be formed from discrete circuitry, an application-specific-integrated-circuit (“ASIC”), or any other type of control circuitry. The third electronic control unit 68 is operatively connected to the first electronic control unit 22 of the first assembly 16 and receives the control signals, which corresponds to the sensed torques and angular positions of the steering wheel 12, from the first electronic control unit. The third electronic control unit 68 is responsive to the control signal from the first electronic control unit 22 for controlling actuation of the third electric motor 70.

The third electric motor 70 is operatively connected to the power steering gear 28. The third gear 44 of the second gear assembly 36 is fixed for rotation on an output shaft 72 of the third electric motor 70. The third electric motor 70 is a reversible motor. The third electronic control unit 68 is responsive to the control signals for controlling the direction of rotation of the output shaft 72 of the third electric motor 56. The third electronic control unit 68 also controls the speed and applied torque of the third electric motor 72.

When the third electric motor 70 is operated, the output shaft 72 of the third electric motor 70 rotates the third gear 44 of the second gear assembly 36. Rotation of the third gear 44 causes the first gear 38 of the second gear assembly 36 to rotate, which in turn, causes rotation of the input shaft 40 of the power steering gear 28. As is described in detail below, rotation of the input shaft 40 of the power steering gear 28 results in movement of the steerable wheels of the vehicle.

As illustrated in FIGS. 1 and 3, the second and third electronic control units 54 and 68 are operatively connected with one another via a bus 84. The second and third electronic control units 54 and 68 communicate with one another through signals transferred via the bus 84. The communication between the second and third electronic control units 54 and 68 includes communications regarding the status of the first and second drive units 30 and 32. For example, the second and third electronic control units 54 and 68 may send signals to one another indicating whether their associated drive units 30 and 32 are operational or are inoperable. If, for example, a malfunction or failure occurs in the second drive unit 32, the third electronic control unit 68 will shut down the operation of the third electric motor 70 and will send a signal to the second electronic control unit 54 of the first drive unit 30 that the second drive unit is inoperable.

As illustrated in FIG. 3, each of the second and third electronic control units 54 and 68 may include a watchdog circuit 88 and 90, respectively. The watchdog circuits 88 and 90 are operable for outputting signals at predetermined intervals. The third electronic control unit 68 receives the watchdog signal output from the watchdog circuit 88 of the second electronic control unit 54 and the second electronic control unit 54 receives the watchdog signal output from the watchdog circuit 90 of the third electronic control unit 68. When one of the watchdog circuits 88 or 90 fails to output a watchdog signal at the predetermined interval, it may be assumed that an error has occurred in the associated electronic control unit 54 or 68. Thus, the watchdog circuit 88 provides an indication of the operability of the first drive unit 30 to the third electronic control unit 68 of the second drive unit 32 and the watchdog circuit 90 provides an indication of the operability of the second drive unit 32 to the second electronic control unit 54 of the first drive unit 30.

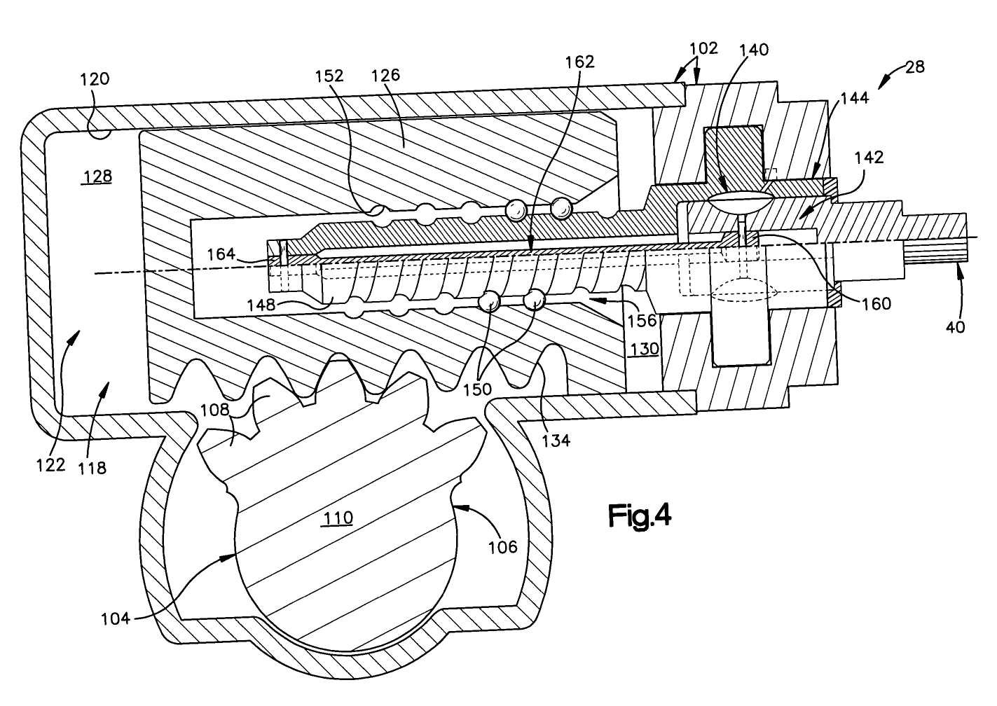

The power steering gear 28 of the second assembly preferably is an integral hydraulic power steering gear. Other steering gears also are contemplated by this invention, such as, for example, rack and pinion steering gears and electric power steering gears. An exemplary integral hydraulic powered steering gear 28 is illustrated in FIG. 4.

The power steering gear 28 includes a housing 102 and a drive mechanism 104. The drive mechanism 104 is moved in response to rotation of the input shaft 40 of the power steering gear 28. Motion of the drive mechanism 104 results in a turning of the steerable wheels of the vehicle.

The drive mechanism 104 includes a sector gear 106 having a plurality of teeth 108. The sector gear 106 is fixed on an output shaft 110 that extends outwardly through an opening in the housing 102 of the power steering gear 28. The output shaft 110 is typically connected to a pitman arm (not shown) that is connected to the steering linkage (not shown) of the vehicle. Thus, as the sector gear 106 rotates, the output shaft 110 is rotated to operate the steering linkage. As a result, the steerable wheels of the vehicle are turned.

The power steering gear 28 further includes a hydraulic motor 118 for moving the drive mechanism 104. The hydraulic motor 118 is located within the housing 102 of the power steering gear 28. The housing 102 of the power steering gear 28 has an inner cylindrical surface 120 defining a chamber 122. A piston 126 is located within the chamber 122 and divides the chamber into opposite chamber portions 128 and 130. One chamber portion 128 is located on a first side of the piston 126 and the other chamber portion 130 is located on a second side of the piston 126. The piston 126 creates a seal between the respective chamber portions 128 and 130 and is capable of axial movement within the chamber 122.

A series of rack teeth 134 is formed on the periphery of the piston 126. The rack teeth 134 act as an output for the hydraulic motor 118. The rack teeth 134 mesh with the teeth 108 formed on the sector gear 106 of the drive mechanism 104. When the piston 126 moves axially, the rack teeth 134 of the piston 126 interact with the teeth 108 of the sector gear 106 to rotate the sector gear.

A pump (not shown) that is associated with the power steering gear 28 supplies hydraulic fluid from a reservoir (not shown) to the hydraulic motor 118. Typically, the engine (not shown) of the vehicle drives the pump. However, the pump could be driven otherwise, such as by a dedicated electric motor. The pump forces hydraulic fluid into an inlet (not shown) of the housing 102. The inlet directs the flow of the hydraulic fluid to a directional control valve 140.

The directional control valve 140 directs the hydraulic fluid to an appropriate chamber portion 128 or 130 of the hydraulic motor 118. The flow of hydraulic fluid toward one of the chamber portions 128 or 130 increases the pressure within that chamber portion. When the pressure of one chamber portion 128 or 130 increases relative to the pressure of the other chamber portion, the piston 126 moves axially until the pressure within the chamber portions 128 and 130 again equalizes. As the piston 126 moves axially, the volume of one chamber portion 128 or 130 increases and the volume of the other chamber portion decreases. The chamber portion 128 or 130 that decreases in volume is vented to allow a portion of the hydraulic fluid contained in the chamber portion to escape. The escaping hydraulic fluid exits the housing 102 via an outlet (not shown) and is directed back to the reservoir.

Directional control valves are known in the art of hydraulic power steering gears. The directional control valve 140 of FIG. 4 includes a valve core part 142 and a valve sleeve part 144. Only portions of the valve core part 142 and the valve sleeve part 144 are illustrated in FIG. 4. As FIG. 4 illustrates, the valve core part 142 is located within and is rotatable relative to the valve sleeve part 144.

The valve core part 142 is fixed for rotation with the input shaft 40 of the steering gear 28. The valve sleeve part 144 and a follow-up member 148 form an integral one-piece unit that is supported for rotation relative to the piston 126 by a plurality of balls 150. The outer periphery of the follow-up member 148 is threaded. The plurality of balls 150 interconnects the threaded outer periphery of the follow-up member 148 with an internal thread 152 formed in a bore 156 of the piston 126. As a result of the interconnecting plurality of balls 150, axial movement of the piston 126 causes the follow-up member 148 and the valve sleeve part 144 to rotate.

Rotation of the valve core part 142 of the directional control valve 140 relative to the valve sleeve part 144 directions hydraulic fluid toward one of the chamber portions 128 and 130 and vents the other chamber portion so as to cause axial movement of the piston 126 within the chamber 122. The axial movement of the piston 126 rotates the sector gear 106 and results in turning of the steerable wheels of the vehicle. The axial movement of the piston 126 also rotates the follow-up member 148 and the valve sleeve part 144 relative to the valve core 142 to return the directional control valve 140 to a neutral position.

A first end 160 of a torsion bar 162 is fixed relative to the input shaft 40 and the valve core part 142. A second end 164 of the torsion bar 162 is fixed relative to the valve sleeve part 144 and the follow-up member 148. When the resistance to turning of the steerable wheels of the vehicle is below a predetermined level, rotation of the input shaft 40 of the steering gear 28 is transferred through the torsion bar 162 and causes rotation of the follow-up member 148. As a result, the directional control valve 140 remains in the neutral position. Rotation of the follow-up member 148 causes movement of the piston 126 and results in turning of the steerable wheels.

When resistance to turning the steerable wheels of the vehicle is at or above the predetermined level, rotation of the follow-up member 148 and the valve sleeve part 144 is resisted. As a result, rotation of the input shaft 40 of the power steering gear 28 results in a twisting of the torsion bar 162 and rotation of the valve core part 142 relative to the valve sleeve part 144. As discussed above, when the valve core part 142 rotates relative to the valve sleeve part 144, hydraulic fluid is directed toward one of the chamber portions 128 or 130 and the other chamber portion is vented. As a result, the piston 126 moves within the chamber 122. Movement of the piston 126 results in turning of the steerable wheels of the vehicle, as well as, rotation of the follow-up member 148. As discussed above, rotation of the follow-up member 148 rotates the valve sleeve part 144 relative to the valve core part 142 to remove the torsion from the torsion bar 162 and return the directional control valve 140 to the neutral position.

With reference again to FIG. 1, the position sensor 34 of the second assembly 26 of the steering apparatus 10 senses the position of the output shaft 110 of the drive mechanism 104 of the power steering gear 28 and outputs a position signal indicative of the sensed position. The position sensor 34 preferably is a non-contacting position sensor. The second and third electronic control units 54 and 68 receive the position signal from the position sensor 34. The position signal operates as a feedback signal for the second and third electronic control units 54 and 68 for indicating whether actuation of the power steering gear 28 resulted in proper movement of the output shaft 110.

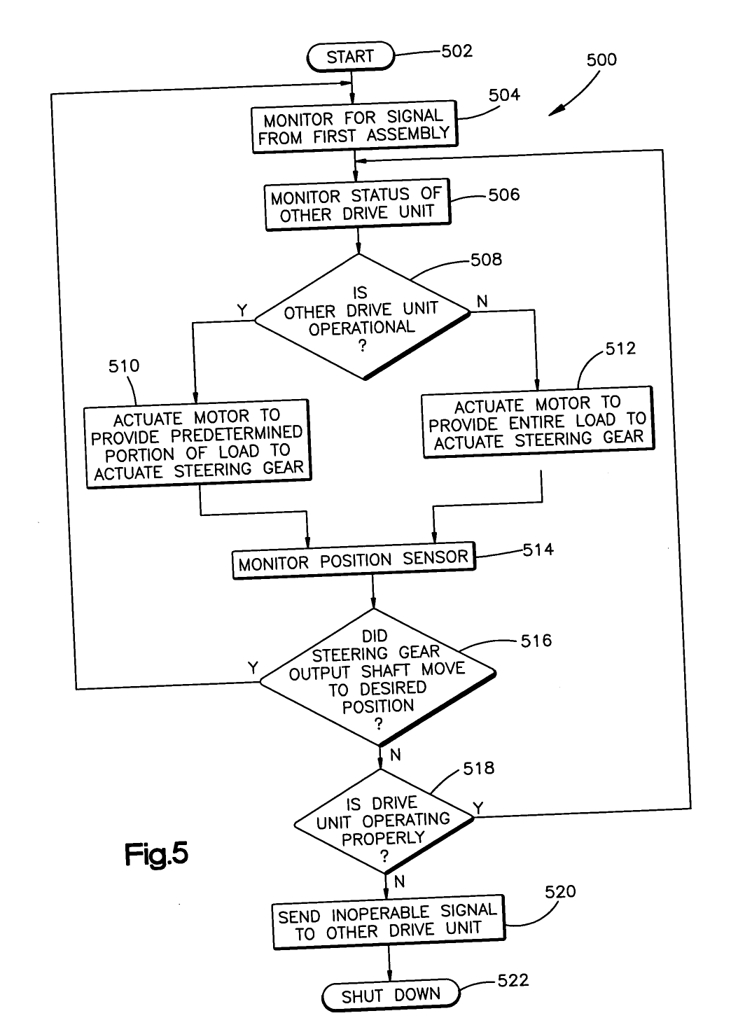

FIG. 5 is a flow diagram illustrating an exemplary process 500 performed by an electronic control unit of a drive unit of a steering apparatus constructed in accordance with the present invention. As an example, the process 500 of FIG. 5 is described below with reference to the second electronic control unit 54 of the first drive unit 30 of the second assembly 26 of the steering apparatus of FIG. 1. The third electronic control unit 68 of the second drive unit 32 may perform a similar process.

The process 500 begins at step 502 in response to the steering apparatus 10 being powered on, for example, in response to turning on the ignition (not shown) of the vehicle. From step 502, the process 500 proceeds to step 504 in which the second electronic control unit 54 monitors for a control signal indicative of the applied torque and angular position of the steering wheel 12 from the first electronic control unit 22 of the first assembly 16.

At step 506, the second electronic control unit 54 monitors the status of the second drive unit 32. To monitor the status of the second drive unit 32, the second electronic control unit 54 of the first drive unit 30 monitors communications, including the watchdog signals, that are sent from the third electronic control unit 68 over the bus 84 (FIG. 3). From step 506, the process 500 proceeds to step 508.

At step 508, a determination is made as to whether the second drive unit 32 is operational. When the determination at step 508 is affirmative and the second drive unit 32 is operational, the process 500 proceeds to step 510 and the second electronic control unit 54 actuates the second electric motor 56 to provide a predetermined portion of the load necessary for actuating the power steering gear 28. For example, when the second and third electric motors 54 and 70 are identical and each of the first and second drive units 30 and 32 is operational, the second and third electric motors 54 and 70 may each provide half of the load necessary for actuating the power steering gear 28. From step 510, the process 500 proceeds to step 514.

When the determination at step 508 is negative and the second drive unit 32 is inoperable, the process 500 proceeds to step 512. At step 512, the second electronic control unit 54 actuates the second electric motor 56 to provide the entire load necessary for actuating the power steering gear 28. From step 512, the process 500 proceeds to step 514.

At step 514, the second electronic control unit 54 monitors the position sensor 34. At step 516, a determination is made as to whether the output shaft 110 of the power steering gear 28 has moved to the desired position. When the determination at step 516 is affirmative and the output shaft 110 has moved to the desired position, the process 500 returns to step 504 and the process is repeated.

When the determination at step 516 is negative and the output shaft 110 has not moved to the desired position, the process 500 proceeds to step 518. At step 518, a determination is made as to whether the first drive unit 30 is operating properly. In making the determination at step 518, the second electronic control unit 54 may run known self-diagnostics. Additionally, at step 518, the second electronic control unit 54 may run diagnostics on the second electric motor 56 and the second power source 52 to determine whether each is properly operating. When the determination at step 518 is affirmative and indicates that the first drive unit 30 is properly operating, the process 500 returns to step 506. When the determination at step 518 is negative and the first drive unit 30 is not properly operating, the process 500 proceeds to step 520 and the second electronic control unit 54 sends a signal via bus 84 to the third electronic control unit 68 of the second drive unit 32 to indicate that the first drive unit 30 is inoperable. From step 520, the process 500 proceeds to step 522 in which the first drive unit 30 is shut down.

As the process 500 of FIG. 5 illustrates, when both the first and second drive units 30 and 32 of the second assembly 26 are operational, the first and second drive units 30 and 32 are operated simultaneously for actuating the power steering gear 28. Preferably, each of the first and second drive units 30 and 32 provides half of the load necessary for actuating the power steering gear 28. It is advantageous to operate both the first and second drive units 30 and 32 simultaneously as losses resulting from rotating the rotor of a shutdown electric motor are avoided. When one of the first and second drive units 30 or 32 becomes inoperable, the other one of the first and second drive units 30 and 32 operates to provide the entire load necessary for actuating the power steering gear 28.

From the above description of the invention, those skilled in the art will perceive improvements, changes and modifications. Such improvements, changes and modifications within the skill of the art are intended to be covered by the appended claims.

Having described the invention, the following is claimed:

1. A steering apparatus for turning steerable wheels of a vehicle in response to rotation of a steering wheel, the steering apparatus comprising:
a first assembly operatively coupled to the steering wheel and including components for sensing conditions of the steering wheel and for providing a control signal indicative of the sensed conditions; and
a second assembly including a steering gear for, when actuated, turning the steerable wheels of the vehicle, the second assembly also including first and second drive units, each of the first and second drive units being operatively connected to an input shaft of the steering gear and being responsive to the control signal for actuating the steering gear,
the second assembly having first and second modes of operation, the first and second drive units operating simultaneously in response to the control signal for actuating the steering gear when the second assembly is operating in the first mode of operation, only one of the first and second drive units being operated in response to the control signal for actuating the steering gear when the second assembly is operating in the second mode of operation.

2. The steering apparatus of claim 1 wherein, when the second assembly is operating in the first mode of operation, the first drive unit provides a first portion of a load associated with actuation of the steering gear and the second drive unit provides a second portion of the load associated with actuation of the steering gear.

3. The steering apparatus of claim 1 wherein, when the second assembly is operating in the first mode of operation, the first portion of the load associated with actuation of the steering gear is approximately equal to the second portion of the load associated with actuation of the steering gear.

4. The steering apparatus of claim 1 wherein the first mode of operation is a normal operating mode and the second mode of operation is a fail-safe operating mode, the second assembly operating in the first mode of operation when both of the first and second drive units are properly responsive to the control signal and operating in the second mode of operation when one of the first and second drive units fails to be properly responsive to the control signal.

5. The steering apparatus of claim 1 wherein the first and second drive units have first and second controllers, respectively, the first and second controllers being operatively connected with one another and communicating with one another so as to enable the second assembly to automatically switch from the first mode of operation to the second mode of operation in response to determining an improper response of one of the first and second drive units.

6. The steering apparatus of claim 1 wherein a gear assembly operatively connects the first and second drive units to the steering gear, the gear assembly including a driven gear that is fixed to the input shaft of the steering gear, a first drive gear that is associated with the first drive unit and that is in meshing engagement with the driven gear for driving the driven gear, and a second drive gear that is associated with the second drive unit and that is in meshing engagement with the driven gear for driving the driven gear.

7. The steering apparatus of claim 6 wherein the first and second drive gears are worm gears and the driven wheel is a worm wheel.

8. The steering apparatus of claim 1 wherein the steering gear is a hydraulic power steering gear.

9. A steering apparatus for turning steerable wheels of a vehicle in response to rotation of a steering wheel, the steering apparatus comprising:
a first assembly operatively coupled to the steering wheel and including components for sensing conditions of the steering wheel and for providing a control signal indicative of the sensed conditions; and
a second assembly including a steering gear for, when actuated, turning the steerable wheels of the vehicle, the second assembly also including first and second drive units, each of the first and second drive units being operatively connected to an input shaft of the steering gear and being responsive to the control signal for actuating the steering gear, the second assembly including a gear assembly for operatively connecting the first and second drive units to the steering gear, the gear assembly including a worm wheel that is fixed to the input shaft of the steering gear, a first worm gear that is associated with the first drive unit and that is in meshing engagement with the worm wheel for driving the worm wheel, and a second worm gear that is associated with the second drive unit and is in meshing engagement with the worm wheel for driving the worm wheel.

10. The steering apparatus of claim 9 wherein the second assembly has first and second modes of operation, the first and second drive units operating simultaneously in response to the control signal for actuating the steering gear when the second assembly is operating in the first mode of operation, only one of the first and second electric motors being operated in response to the control signal for actuating the steering gear when the second assembly is operating in the second mode of operation.

11. The steering apparatus of claim 10 wherein, when the second assembly is operating in the first mode of operation, the first drive unit provides a first portion of a load associated with actuation of the steering gear and the second drive unit provides a second portion of the load associated with actuation of the steering gear.

12. The steering apparatus of claim 10 wherein, when the second assembly is operating in the first mode of operation, the first portion of the load associated with actuation of the steering gear is approximately equal to the second portion of the load associated with actuation of the steering gear.

13. The steering apparatus of claim 12 wherein the first mode of operation is a normal operating mode and the second mode of operation is a fail-safe operating mode, the second assembly operating in the first mode of operation when both of the first and second drive units are properly responsive to the signal and operating in the second mode of operation when one of the first and second drive units fails to be properly responsive to the signal.

14. The steering apparatus of claim 10 wherein the first and second drive units have first and second controllers, respectively, the first and second controllers being operatively connected with one another and communicating with one another so as to enable the second assembly to automatically switch from the first mode of operation to the second mode of operation in response to determining an improper response of one of the first and second drive units.

15. The steering apparatus of claim 9 wherein the first drive unit includes a first electric motor and an associated first controller, the second drive unit including a second electric motor and an associated second controller, the first worm gear being fixed for rotation with an output shaft of the first electric motor and the second worm gear being fixed for rotation with an output shaft of the second electric motor.

16. The steering apparatus of claim 9 wherein the steering gear is a hydraulic power steering gear.
